(19) United States
(12) Patent Application Publication
(10) Pub. No.: US 2014/0280490 A1
(43) Pub. Date: Sep. 18, 2014

(54) SYSTEMS AND METHODS FOR VISUAL COMMUNICATION

(71) Applicant: Atakan Artun, Bell Canyon, CA (US)

(72) Inventor: Atakan Artun, Bell Canyon, CA (US)

(21) Appl. No.: 13/843,799

(22) Filed: Mar. 15, 2013

(51) Int. Cl. H04L 29/06

(52) U.S. Cl. CPC H04L 65/60
USPC 709/203

(57) ABSTRACT

Various systems and methods described herein relate to visual communication. Various embodiments may facilitate visual communication sessions that enable: presentation of a video stream with a data content overlay that is under the control of a session participant acting as an operator (hereafter, referred to as a “presentation operator”); video-based puppeteering; collection of analytical information regarding visual communication sessions; secure submission of information through visual communication sessions; and/or fine-grained permissions of session participants.

### BACKGROUND

1. Technical Field

The present invention(s) generally relate to communications and, more particularly, visual communication systems configured for user interaction.

2. Description of Related Art

Communications technology has long been utilized in business customer service. Telephone calls, e-mail, and online chats sessions are just some examples of communication methods traditionally used by businesses to provide services to its customers. Essentially, such communications methods allow a business to remotely provide a consumer with customer service without need for the business to have physical/in-person presence at the consumer's location. It is common for consumers to contact businesses by phone, by e-mail, or through their website for customer service purposes, such as obtain product or service information, ask questions, conduct business, or facilitate transactions.

Call centers staffed with customer representatives have often been a useful customer service tool, particularly for those businesses that serve a large numbers of consumers or serve consumers over a large geographic area. Several businesses have even equipped their respective websites with chat systems that enable customer representatives to initiate online chat discussions through the websites with consumers that visit the websites. In some instances, such chat systems have not only improved the quality of customer service provided by businesses, but have also boosted sales for various businesses. Development continues on various communications technologies that assist businesses improve consumer experience of customer service.

### SUMMARY

Various systems and methods described herein relate to visual communication. As used herein, session participant refers to individuals participating in a visual communication session in accordance with various embodiments. Various embodiments may facilitate visual communication sessions that enable: presentation of a video stream with a data content overlay that is under the control of a session participant acting as an operator (hereafter, referred to as a “presentation operator”); video-based puppeteering; collection of analytical information regarding visual communication sessions; secure submission of information through visual communication sessions; and/or fine-grained permissions of session participants.

As used herein, the term “presentation” refers to what results from presenting a data content presentation layer over the video stream layer. The term viewer can refer to those one or more that receive a presentation that is under a presentation operators control. Additionally, for some embodiments, session participants may have specific roles and/or privileges within the visual communication session. As understood herein, a session participant at a viewing client may be referred to as a viewer, while a session participant controlling the presentation of the video stream and/or the data content to a viewing client is referred to as a presentation operator.

According to some embodiments, a method is provided for visual communication. The method may comprise: generating a link corresponding to a visual communication session between a viewing client and a presentation server; and establishing the visual communication session between the viewing client and the presentation server based on the link. The visual communication session established may comprise a video stream layer configured to present a video stream to the viewing client, and a data content presentation layer configured to present data content to the viewing client over the video stream layer. For some embodiments, the data content presentation layer is presented as an overlay disposed over the video stream layer. As an overlay, the data content presentation layer may possess some level of transparency that permits the viewer to observe the video stream layer underlying the data content presentation layer.

In some embodiments, the data content presentation layer is disposed over the video stream layer such that to an individual viewing the video stream layer and the data content presentation layer in combination (e.g., the viewer), the individual presented in the video stream layer appears to be touching, handling, moving, or otherwise controlling the data content being presented through the data content presentation layer.

The method may further comprise presenting to the viewing client the video stream layer, and presenting to the viewing client the data content presentation layer over the video stream layer. Depending on the embodiment, the presentation the data content presentation layer over the video stream layer may comprise separately transmitting video stream layer separate and the data content presentation layer to the viewing client and instructing the viewing client to overlay the viewing client to dispose the data content presentation layer over the video stream layer. In addition, the presentation the data content presentation layer over the video stream layer may comprise adapting the data content presentation layer to be presented over the video stream layer (e.g., with respect to size, location, orientation, or transparency of the data content presentation layer).

Those skilled in the art will appreciate that embodiments may vary in the number of video stream layers simultaneously presented to the viewing client and/or the number of data content presentation layers simultaneously presented to the viewing client during a given visual communication session.

Those skilled in the art will also appreciate that during a visual communication session, a video stream layer originating from the viewing client may be presented to the presentation server. For some embodiments, the video stream layer presented to the presentation server may comprise a video stream of the viewer captured at the viewing client, which may facilitate two-way video conferencing between the viewer and the presentation operator.

The presentation of the video stream layer and/or the data content presentation layer may be controlled by a presentation operator through the presentation server. Control of the video stream layer and/or the data content presentation layer can include: determining what video content is to be presented through the video stream layer; what data content is to be presented in the data content presentation layer; the size, location, transparency, shape, or orientation of the data content presentation layer as it is presented over the video stream layer; starting, pausing, or ending presentation of the video stream layer and/or the data content presentation layer.

The data content presentation layer may present content from a computer readable object. Example of computer readable objects can include computer readable document files (e.g., Microsoft® Word file), spreadsheet files (e.g., Microsoft® Excel® file), presentation file (e.g., Microsoft® PowerPoint® file), multimedia files (e.g., AVI or MOV video files, or WAV or MP3 audio files), image files (e.g., BMP or JPG files), data from a database, and the like. In some embodiments, the computer readable object presented may accessible by the viewing client but not otherwise accessible by the presentation server. For example, the file from which content is presented through the data content presentation layer may be stored at the viewing client, and may not be accessible to the presentation server but for the access permitted through an embodiment. Alternatively, the computer readable object presented may be accessible by the presentation server but not otherwise accessible by the viewing client. For instance, the file from which content is presented through the data content presentation layer may be stored at the presentation server, and may not be accessible to the viewing client but for the access permitted through an embodiment. For certain embodiments, the computer readable object may store at a computer system (e.g., a media library server) separate and distinct from the viewer client and the presentation server, and either a viewer at the viewing client or a presentation operator at the presentation server can request the presentation server to access the computer readable object from the separate and distinct computer system.

The method may additionally comprise receiving user input data received, through the data content presentation layer, from a viewer at the viewing client. According to some embodiments, the data content presentation layer may present a computer-fillable form configured to receive user input data from a viewer at the viewing client. User input data received may include, for example, information facilitating a transaction, personal information, user login information, medical information, and other information confidential to the user.

In some embodiments, the data content presentation layer may present a download link corresponding to a computer readable object downloadable by the viewing client. The download link may be configured to be used (e.g., traversed) by a viewer at the viewing client in order to download the corresponding computer readable object to the viewing client. Presentation of the download link to the viewing client may comprise presenting a hyperlink through the data content presentation layer and/or presenting a visual representation of the download link through the data content presentation layer, such an icon that a viewer can click on.

In various embodiments, the video stream layer may present a set of pre-recorded videos selected by the presentation operator, and may present them in an order determined/selected by the presentation operator. Additionally, the set of pre-recorded videos may be presented such that video stream layer appears to presenting live video. In this way, the presentation operator can give the viewer a similar look and feel of a live video session through the use of a library of pre-recorded video clips. For example, these features may enable the presentation operator to perform video-based puppeteering through the video stream layer. As used herein, “video-based puppeteering” refers to where a presentation operator controls a sequence of one or more selected pre-recorded videos of an individual, performing different movements, as to give the appearance that the presentation operator is controlling the movement of the individual at or near real-time over live video. In doing so, the presentation operator appears to be puppeteer controlling the individual.

In certain embodiments, the link uniquely may correspond to the visual communication session. Furthermore, the link may be configured to be disabled while the visual communication session is active, and configured to be enabled/re-enabled when the visual communication session is inactive.

The method of some embodiments may further comprise collecting analytical information regarding the visual communication session. For example, while the visual communication session is active, the analytical information collected may include a log of data content sent between the viewing client and the presentation server, a log of interactions by session participants, metrics regarding the visual communication session, description regarding nature of the visual communication session, and the like. The analytical information collected may be exported to and/or utilized by various analytical tools known in the art.

According to some embodiments, a system is provided for visual communication. The system may comprise: a link module configured to generate a link corresponding to a visual communication session between a viewing client and a presentation server; a visual communication session module configured to establish the visual communication session between the viewing client and the presentation server based on the link; a video stream module configured to present to the viewing client the video stream layer; a data content presentation module configured to present to the viewing client the data content presentation layer over the video stream layer; and a presentation operator control module configured to allow a presentation operator to control the presentation of the video stream layer by the video stream module and/or the presentation of the data content presentation layer by the data content presentation module.

Various embodiments may be implemented as a computer program product comprising computer instruction codes configured to cause the computer system to perform the operations described herein.

Other features and aspects of various embodiments will become apparent from the following detailed description, taken in conjunction with the accompanying drawings, which illustrate, by way of example, the features of such embodiments.

### BRIEF DESCRIPTION OF THE DRAWINGS

Various embodiments are described in detail with reference to the following figures. The drawings are provided for purposes of illustration only and merely depict some embodiments. These drawings shall not be considered limiting of the breadth, scope, or applicability of embodiments.

FIG. 1 is a block diagram illustrating an environment utilizing an example system for visual communication in accordance with various embodiments.

FIG. 2 is a block diagram illustrating an example presentation server for visual communication in accordance with various embodiments.

FIG. 3 is a block diagram illustrating an example viewing client for visual communication in accordance with various embodiments.

FIG. 4 is a flowchart illustrating an example method for visual communication in accordance with various embodiments.

FIG. 5 is a block diagram illustrating an example user interface for visual communication in accordance with various embodiments.

FIG. 6 is a screenshot of an example mobile viewing client participating in visual communication in accordance with various embodiments.

FIG. 7 is a screenshot of an example mobile viewing client participating in visual communication in accordance with various embodiments.

FIG. 8 is a screenshot of an example mobile viewing client participating in visual communication in accordance with various embodiments.

FIG. 9 is a block diagram illustrating an exemplary digital device that can be utilized in the implementation of various embodiments.

### DETAILED DESCRIPTION

Various systems and methods described herein relate to visual communication. Various embodiments may facilitate visual communication sessions that enable: presentation of a video stream with a data content overlay under the control of a session participant acting as an operator (hereafter, referred to as a “presentation operator”); video-based puppeteering; collection of analytical information regarding visual communication sessions; secure submission of information through visual communication sessions; and/or fine-grained permissions of session participants.

Certain embodiments may facilitate visual communication session as a visual interactive call session. In a visual interactive call session, a caller types or clicks on unique universal resource locator (URL), received (e.g., by text message or email) during a phone call with a call operator. Upon the caller using the link, the visual interactive call session commences between the caller and the call operator, with the caller acting as the viewer and the call operator acting as the presenter. The caller may use the link during the phone call, whereby the phone call switches to a visual interactive call session upon use of the link. Alternatively, the call may use the link after the phone call has ended.

During the visual interactive call session, the viewer may be provided with interactive guidance from the presenter by way of a presentation comprising a broadcast quality video stream and a data content layer disposed (e.g., overlain) over the video stream, possibly with some level of transparency. The viewer may further input data, co-browse, perform visual sharing, drag and drop files to the data content layer, play media (e.g., video) and do pretty much anything. In some embodiments, the data content presentation layer may function as a shared area data content area, through which viewer can present data content to the presenter (e.g., by dragging and dropping a file into the data content presentation layer).

Various embodiments may enable session participants to interact with visual communication session in real-time, which can include clicking, scrolling, typing, and browsing through the visual communication session without having to pass control of the session back and forth between participants. Certain embodiments may be accessible by session participants through web-based interfaces provided to session participants (e.g., the viewer and/or the presentation operator) through a web browser. The browser utilized by session participants may differ in type or version. In some embodiments, a visual communication session may involve a viewer accessing the visual communication session through a mobile web browser operating on a mobile viewing client, such as mobile phone or tablet. For certain embodiments, the same may be true of the presentation operator.

There are several cases/scenarios in which the system and methods described herein may be useful. For example, an embodiment may be useful in facilitating visual communication sessions between patients and the doctors, possibly using the visual interactive call session described above. Embodiments may enable the patient and doctor to establish one-way doctor-to-patient video conference or a two-way video conference (e.g., where doctor and patient see each other), and may further enable the doctor to present x-rays, medical records, and the like through a data content presentation layer overlain over the doctor's video stream received by the patient.

In another example, an embodiment may enable a student to have a visual interactive speech/OT/PT session with a special education provider over a visual communication session. The special education provider may present the data content relating to the speech/OT/PT session through a data content presentation layer, which may be partially transparent such that the student can view the session data content and the video stream of the special education provider presented through video stream layer.

Further instances where visual communication sessions, such as visual interactive calls, may be useful include: where a customer calls a flower shop to order flowers and wants to see options, where a customer calls a travel agency to make travel arrangement and wants to visually review rental car options; customer calls a bank to look at home mortgage refinancing prices or review/finalize bank documents; customer calls a retail store to learn more about store's physical inventory or order an item; an engineer calls a manufacturing facility to look at materials or go over the design process as detailed in computer documents; and client calls a law firm to review documents or finalize the filing documents.

Through use some embodiments, businesses can provide consumers with customer service similar to in-person customer service. Embodiments may enable some businesses to achieve closing rates closer to those of brick and mortar, retail stores.

FIG. 1 is a block diagram illustrating an environment 100 utilizing an example system for visual communication in accordance with various embodiments. As shown in FIG. 1, the exemplary environment 100 may comprise a presentation server 102 and a viewing client 106, each of which may be communicatively coupled with each other by way of a network 104. In some embodiments, the network 104 may comprise one or more local or wide-area communications networks, such as the Internet, WiFi networks, WiMax networks, and the like. Depending on the embodiments, some or all of the communication connections with the network 104 and within the network 104 may utilize encryption (e.g., Secure Sockets Layer [SSL]) to secure information being transferred between the presentation server 102 and the viewing client 106.

The presentation server 102 and the viewing client 106 may be implemented using one or more digital devices, which may be similar to the digital devices discussed later with respect to FIG. 9. For instance, the presentation server 102 and/or the viewing client 106 may be any form of computing device capable of receiving user input (e.g., configured for user interaction), capable of displaying a client user interface (e.g., through which a visual communication session can be viewed or controlled), and capable of communicating with the presentation server 102 over the network 104. Such computing devices may include a mobile phone, a tablet computing device, a laptop, a desktop computer, personal digital assistant, a portable gaming unit, a wired gaming unit, a thin client, a set-top box, a portable multi-media player, or any other type of network accessible user device known to those of skill in the art. Further, the presentation server 102 and/or the viewing client 106 may comprise of one or more servers, which may be operating on or implemented using one or more cloud-based services (e.g., System-as-a-Service [SaaS], Platform-as-a-Service [PaaS], or Infrastructure-as-a-Service [IaaS]). It will be appreciated by those skilled in the art that the presentation server 102 and/or the viewing client 106 may be implemented as processes operating on one or more servers and/or using one or more cloud-based services.

The presentation server 102 may be configured to establish a visual communication session with the viewing client 106, and present the viewing client 106 with a video stream layer and a data content presentation layer disposed over the video stream layer. The visual communication session may be established between a presentation operator accessing the presentation server 102 and a viewer accessing the viewing client 106. The presentation operator may access the presentation server 102 through a graphical user interface (GUI) provided by the presentation server 102, possibly through a website that the presentation operator can access at the presentation server 102 or at a computer system connected to the presentation server 102 (e.g., through the network 104). Likewise, the viewer may access the viewing client 106 through a graphical user interface (GUI) provided by the viewing client 106, possibly through a website that the viewer can access at the viewing client 106 or at a computer system connected to the viewing client 106 (e.g., through the network 104).

Reference to “a presentation operator at a presentation server,” unless stated otherwise, can include a presentation operator directly accessing a presentation server and a presentation operator remotely accessing the presentation server through a computer system connected to the presentation server. Similarly, reference to “a viewer at a viewing client,” unless stated otherwise, can include a viewer directly accessing a viewing client and a viewer remotely accessing the viewing client through a computer system connected to the viewing client.

To establish the visual communication session, the presentation server 102 may generate a link corresponding to the visual communication session and provide the link to the viewing client 106, for example, by text message, e-mail, or electronic schedule reminder. Initiation and establishment of the visual communication session may follow once the viewer at the viewing client 106 uses (e.g., traverses) the link provided by the presentation server 102.

Once the visual communication session is established, a presentation operator can control what is being presented to the viewing client 106 through the video stream layer and/or data content presentation layer and how they are respectively being presented. For instance, through the presentation server 102, the presentation operator can control the video stream layer such that it comprises live video of the presentation operator (e.g., as captured through a camera) and/or a set of pre-recorded videos (e.g., through which the presentation operator performs video-based puppeteering). As another example, the presentation operator may control the size or shape of the data content presentation layer, and its position over the video stream layer, as the data content presentation layer is presented to the viewing client 106. Data content may be provided by one or more computer readable objects, which may reside at the presentation server 102, the viewing client 106, and/or some separate computer system (e.g., media library server).

Additionally, data content presented may comprise a computer-fillable form configured to receive user input data at the viewing client 106. Upon submission of the computer-fillable form, some or all of the user input data may be provided to the presentation operator at the presentation server 102, and some or all of the user input data may be provided to a computer system separate from the presentation server 102. For some embodiments, some or the entire user input data may be received by the presentation server 102 and/or the separate computer system while denying the presentation operator access to the user input data. By doing so, certain embodiments can ensure confidentiality of information submitted through a data content presentation layer by a viewer, while reducing the likelihood of inadvertent disclosure or misappropriation of the information submitted.

Control of the video stream layer and/or the data content presentation layer may be facilitated through a user interface, such as a web-based interface, provided to the presentation operator by the presentation server 102. With the user interface, the presentation operator can control aspects of the data content presentation layer through drag-and-drop actions. For example, moving the location or size of the data content presentation layer, changing the number of data content presentation layers being presented, or specifying/changing the data content being presented through a given data content presentation layer, may involve the presentation operator performing certain drag-and-drop action with respect to the user interface. For instance, to change the data content presented by the data content presentation layer, the presentation operator may drag-and-drop an graphical representation of a file (e.g., icon), provided by a listing of accessible files, to a portion of the user interface graphically representing a data content presentation layer that is currently being presented to the viewing client 106.

In addition to controlling the one or more layers of the visual communication session, the presentation operator's user interface may allow control of other aspects of the visual communication session. For example, the user interface may permit the presentation operator to pause or end a visual communication session, invite one or more additional viewers to an active visual communication session, and/or initiate and/or accept a chat session with the viewer through the visual communication session. Additionally, through the presentation operator's user interface, the presentation operator may configure the data content presentation layer to mask one or more specific portions of data content it presents, such as passwords or confidential information (e.g., for security purposes). As another example, the presentation operator's user interface may enable the presentation operator to define parameters and/or limitations regarding what the viewer at the viewing client 106 can and cannot do. An example of this may include the presentation operator restricting the viewer from inputting data into the data content presentation layer or clicking on buttons presented in the data content presentation layer.

With respect to video-based puppeteering, the presentation operator's user interface may allow the presentation operator to control selection, sequencing, and/or playing of pre-recorded videos, which effectively provides the presentation operator with control over the video-based puppet's movements. To make possible link-based downloads by the viewing client 106, the presentation operator's user interface may provide control features that enable the presentation operator to select a computer readable object, and provide the viewing client 106 with a download link to the selected computer readable object.

The presentation operator may utilize the presentation operator's user interface to schedule visual communication session for the future. Through the presentation operator's user interface, the presentation operator may cause the presentation server 102 to prepare and generate one or more computer calendar reminders (e.g., iCal®, Google® Calendar, and Outlook®) comprising details regarding a tentatively scheduled visual communication session. Information in the computer calendar reminder can include, for instance, time information, date information, description of subject matter, and a link to the visual communication session.

As noted above, the viewing client 106 may be configured to establish a visual communication session with the presentation server 102. Once the visual communication session is established, the presentation server 102 may present the viewing client 106 with a video stream layer and a data content presentation layer disposed over the video stream layer. Upon receiving the video stream layer and the data content presentation layer, the viewing client 106 may display them, possibly through a video display coupled to the viewing client 106.

In certain embodiments, the viewing client 106 may permit the viewer at the viewing client 106 to control various aspects of the visual communication session. For instance, the viewing client 106 may enable the viewer to pause or end the visual communication session, and/or change options regarding presentation of the video stream layer and/or the data content presentation layer at the viewing client 106. Depending on parameters and/or limitations defined for the visual communication session (e.g., by the presentation operator), the viewer may be allowed to instruct the viewing client 106 to resize and/or re-locate the data content presentation layer, to resize and/or re-locate the video stream layer, to hide/un-hide the data content presentation layer, and/or to hide/un-hide the video stream layer.

The viewer may execute control of the visual communication session at the viewing client 106 through a user interface, such as a web-based interface, provided to the viewer by the viewing client 106. The viewer's control interface may, for instance, allow the viewer to initiate and/or accept a chat session with the presentation operator, facilitate the viewer to enter and submit user input data through the data content presentation layer, utilize download links to download computer readable objects, and/or otherwise control various aspects discussed above with respect to the viewer and the viewing client 106.

In particular embodiments, a visual communication session between the presentation server 102 and the viewing client 106 may be established according to the following. A presentation operator may login to a presentation server 102. This may involve the presentation operator logging into presenter software provided by a web server through the presentation operator's web browser. The presenter software may be configured to provide the presentation operator with access to the visual communication session, possibly through the presentation server 102, once the visual communication session is established. The presentation operator may be located remotely on the network 104 with respect to the presentation server 102 and connected to the presentation server 102 through a digital device, such a personal computer system (e.g., laptop or desktop). Additionally, the web server may be part of the of the presentation server 102.

Subsequent to the presenter software being provided, the presenter software may connect to an application server. The application server may be requested to create a new visual communication session and, in response, the presentation operator may receive from the application server a session code corresponding to the requested new visual communication session. The presentation operator can provide the session code to a viewer at the viewing client 106 who intends to establish a visual communication session.

Through the viewing client 106, the viewer connects to a web server and submits the session code. In response, the web server may provide viewer software through the viewer's web browser (e.g., at the viewing client 106). The viewer software may be configured to provide the viewer access to the visual communication session, possibly through the viewing client 106, once the visual communication session is established. As noted above, the web server may be part of the of the presentation server 102. The web server may retrieve information regarding the new visual communication session and provide that information to the viewing client 106. The viewer software may then connect to the application server to which the presenter software has connected.

Using the presenter software, the presenter operator can send data content, such as such as screen images, chat messages, or files, to the application server, and can send a video stream (e.g., set of pre-recorded videos or a webcam video stream) to a media server. The application server and media server, in turn, can distribute the data content and video stream received from the presenter software to the viewer software of the viewer (e.g., operating through a web browser at the viewing client 106).

Using the viewer software, the viewer at the viewing client 106 can send data content, such as send chat messages or files, to with the presentation operator through the application server. Additionally, through the viewer software, the viewer at the viewing client 106 can send a video stream (e.g., from a cell phone built-in camera) to the media server. The application server and media server, in turn, can distribute the data content and video stream received from the viewer software to the presenter software of presentation operator (e.g., operating through a web browser at the presentation server 102).

FIG. 2 is a block diagram illustrating an example presentation server 102 for visual communication in accordance with various embodiments. As shown in FIG. 2, the presentation server 102 may comprise: a presentation operator graphical user interface (GUI) module 202, a visual communication session module 204, a visual communication session link module 206, a presentation server video stream module 208, a data content presentation module 210, a data content management module 212, a presentation operator presentation control module 214, a presentation server video stream player module 216, a upload module 218, an analytics module 220, a presentation server communication module 222, and a presentation server datastore 224.

According to some embodiments, the operational flow of the presentation server 102 may be according to the following. When the presentation server 102 starts, it may determine whether all connections to dependencies are available and functional for a visual communication session. If some dependency is not functioning, the presentation server 102 may inform the presentation operator that a problem exists. Barring any start-up issues, the presentation operator may create an account, get authorization for the account from an administrator, and then login to the presentation server 102. After a successful login, the presenter operator enters a presenter view area, can change settings (e.g., to visual communication session or the presentation server 102), and interact with a visual communication session using drag-and-drop. For example, the presentation operator may drag-and-drop items into a viewer view area to present to the viewing client, such items as, specific items, icons, and files (e.g., forms, images, or automated task videos). The presentation operator can end or pause the visual communication session at any time (e.g., through the presentation operator's view area). In some embodiments, when the visual communication session is paused, a temporary image may be presented to the viewer at the viewing client 106.

Referring now to FIG. 2, the presentation operator GUI module 202 may be configured to provide a presentation operator with a graphical user interface (GUI) for accessing and/or controlling a visual communication session through the presentation server 102. In general, the GUI provided by the presentation operator GUI module 202 (hereafter, the “presentation operator's GUI”) may enable the presentation operator to interact with various components and functionalities of the presentation server 102. For some embodiments, the presentation operator GUI module 202 may provide the presentation operator's GUI through a website hosted on a web server, which may be part of the presentation server 102. Web-based implementations of the presentation operator's GUI may utilize Adobe® Flash®, HTML 5, Java® and like web-compatible technologies.

The visual communication session module 204 is configured for managing one or more visual communication sessions established between the presentation server 102 and various viewing clients. In some embodiments, the presentation server 102 may be configured to simultaneously host two or more visual communication sessions between multiple session participants. The visual communication session module 204 may manage visual communication sessions by creating new visual communication sessions, assigning existing visual communication sessions to generated links, or removing visual communication sessions. The visual communication session module 204 may further manage visual communication sessions by initiating and establish sessions between the presentation server 102 and the viewing client 106. During session management operations, the visual communication session module 204 may store session information in the presentation server datastore 224. For example, when a session is created, a session is associated with a generated link, and/or a computer calendar reminder is generated for the visual communication session.

The visual communication session link module 206 may be configured to manage links generated and associated with corresponding visual communication sessions. In some embodiments, the visual communication session link module 206 may generate a link in for a corresponding visual communication session, and provide the link to the viewing client 106 to facilitate establishment of the session. In connection with generating a link for a corresponding visual communication session, the visual communication session link module 206 may generate a computer calendar reminder (e.g., Outlook®, iCal®, and Google® Calendar) regarding the visual communication session. The computer calendar reminder may include the link to the visual communication session. For various embodiments, when a link and/or a computer calendar reminder is generated by the visual communication session link module 206, the link and/or the computer calendar reminder, or information regarding to the same, may be stored in the presentation server datastore 224.

The presentation server video stream module 208 may be configured to may be configured to present a video stream from the presentation server 102 to the viewing client 106. Though the video stream presented by the presentation server video stream module 208 may comprise a video stream of the presentation operator (e.g., as captured by a camera coupled to the presentation server 102), the video stream presented by the presentation server video stream module 208 may also comprise a video stream accessible by the presentation server 102 and selected by the presentation operator. For example, the presentation operator may select to stream to the viewing client 106 a video stored locally on the presentation server datastore 224. Depending on the embodiment, the presentation server video stream module 208 may comprise multimedia encoders adapted to generate a video stream decodable by the viewing client 106.

The data content presentation module 210 may be configured to access computer readable object and presenting data content from the computer readable object in a data content presentation layer. Access by the data content presentation module 210 may include, without limit, reading, writing, modifying, and deleting data content in the computer readable content. For some embodiments, the data content presentation module 210 may include a converter that can convert a computer readable object from a first type of object (e.g., MOV) to a second type of object (e.g., AVI). The conversion may be necessary by the data content presentation module 210 for certain object types (e.g., file formats) before the data content presentation module 210 presents content from a computer readable object through a data content presentation layer.

The data content management module 212 may be configured to provide computer readable objects to the data content presentation module 210 for access. In some embodiments, the data content presentation module 210 may instruct the data content management module 212 to obtain a copy a specific computer readable object and to provide the specific computer readable object to the data content presentation module 210. The data content management module 212 may retrieve computer readable objects from the presentation server datastore 224. In some embodiments, the data content management module 212 may be configured to retrieve a computer readable object from a computer system separate from the presentation server 102 (e.g., 3^{rd} party website). The data content management module 212 may be responsible for managing the computer readable objects accessible by the presentation server 102.

The presentation operator presentation control module 214 execute instructions from the presentation operator at the presentation server 102 (e.g., through the presentation operator GUI module 202) in regard to controlling the video stream and/or data content presentation layers being presented by the presentation server 102 (e.g., the presentation server video stream module 208 and the data content presentation module 210). The presentation operator presentation control module 214 may enable the presentation operator to interact with data content being presented through a data content presentation layer provided by the presentation server 102 (e.g., the data content presentation module 210). The presentation operator presentation control module 214 may permit the presentation operator to control the adjust data content presentation layers (e.g., size, move, and orientation) being presented, and may permit the presentation operator to define parameter and/or limitations to what the view at the viewing client 106 can and cannot do during the visual communication session.

The presentation server video stream player module 216 may be configured to receive a video stream layer presented by the viewing client 106 to the presentation server 102, and present the received layer to a video display coupled to the presentation server 102. In some embodiments, the presentation server video stream player module 216 may present the video stream layer through a GUI provided by the presentation operator GUI module 202.

The upload module 218 may be configured to facilitate download of a computer readable object, such as a file, to the viewing client 106 based on a link generated by the upload module 218 and sent to the viewing client 106. The presentation operation may select a computer readable object to be uploaded to the viewing client and request the upload module 218 (e.g., via the presentation operator GUI module 202) to generate a link that would facilitate the upload of the computer readable object. The computer readable object may be uploaded from the presentation server 102 (e.g., the presentation server datastore 224), or be uploaded from a computer system separate from the presentation server 102 (e.g., 3^{rd} party web server). When the computer readable object to be uploaded is provided by the presentation server 102, the upload module 218 may manage access the computer readable object by the viewing client 106.

Upon generating the download link corresponding to the computer readable object, the upload module 218 may provide the download link to the viewing client 106. The viewing client 106 may present the download link as an icon disposed over the video stream layer, or may present the download link as an address or hyperlink. When the viewing client 106 uses (e.g., traverses) the download link, the viewing client 106 may initiate download of the computer readable object to the viewing client 106. In some embodiments, the download link generated may be a hyperlink that facilitates the viewing client 106 downloading the computer readable object view a web site.

Upon receiving the download link from the presentation server 102, viewing client presentation player module 304 may present the link over the video stream layer being received from the presentation server 102, and may present the download link in a data content presentation layer disposed over the video stream layer. As discussed herein, when the download link is presented at the viewing client 106, it may be graphically represented as an icon or the like. Use (e.g., traversal) of the download link by a viewer at the viewing client 106 may initiate download of the computer readable object to the viewing client 106. The downloaded computer readable object may be stored in and subsequently accessible from the viewing client datastore 314. Depending on the embodiment, the download link received from the presentation server 102 may be configured to initiate a download of the corresponding computer readable object from the presentation server 102 or from a computer system separate from the presentation server 102 (e.g., 3^{rd} party server).

The analytics module 220 may be configured to gather detailed information regarding visual communication sessions, and aggregate analytical data from the detailed session information. In some embodiments, the presentation operator or administrator can integrate data from the analytics module 220 to analytics applications well known in the art.

The presentation server communication module 222 may be configured to facilitate communication between the presentation server 102 and the viewing client 106 through the network 104. The various components of the presentation server 102 may utilize the presentation server communication module 222 when transmitting or receiving data to and from the viewing client 106.

FIG. 3 is a block diagram illustrating an example viewing client 106 for visual communication in accordance with various embodiments. As shown in FIG. 3, the viewing client 106 may comprise: a viewing client graphical user interface (GUI) module 302, a viewing client presentation player module 304, a viewer presentation control module 306, a viewing client video stream module 308, a download module 310, a viewing client communication module 312, and a viewing client datastore 314.

According to some embodiments, the operational flow of the viewing client 106 may be according to the following. The viewer may connect to the presentation operator through a phone call, online chat session, an e-mail, or the like. The presentation server 102 generates and distributes (e.g., through text, e-mail or voice mail) a unique URL that when used by the viewer, initiates a visual call session having a video stream layer and a data content presentation layer disposed over the video stream layer. When the viewer uses (e.g., traverses) the URL, the URL may be verified by the presentation server 102. If it is not a valid URL, the viewer may be redirected to an invalid page. If, however, the URL is valid, the visual call session can be initiated and the viewer's identifier is passed to the presentation server 102.

In some instances, if a URL is not found in a user database, viewer access to website that initiates the visual communication session may be blocked and/or the visual communication session associated with the URL may be already in sessions. In the event that a view initiate the visual communication session, the viewer may be automatically redirected to a fallback page. In the event a viewer loses connection, the viewer may need to connect to the visual communication session through the same URL until the presentation operator closes the visual communication session.

In some embodiments, the presentation operator can initiate a phone call with a viewer that eventually leads to a visual interactive call. Additionally, for some embodiments, both presentation operator and a viewer can online chat the visual communication session; a presentation operator can choose to show the chat inside the viewer view area or hide it inside the presentation operator's view area. For some embodiments, once the visual communication session has ended, a viewer may be directed to a message web page that may have other links to service customization, a feedback form, or the like. Inputs received from the web page may be sent to a database.

The viewing client graphical user interface (GUI) module 302 may be configured to provide a viewer with a graphical user interface (GUI) for accessing and/or controlling a visual communication session through the viewing client 106. In general, the GUI provided by the viewing client GUI module 302 (hereafter, the “viewer's GUI”) may enable the viewer to interact with various components and functionalities of the viewing client 106. Web-based implementations of the viewer's GUI may utilize Adobe® Flash®, HTML 5, Java® and like web-compatible technologies.

The viewing client presentation player module 304 may be configured to receive a video stream layer and/or data content presentation layer presented to the viewing client 106 by the presentation server 102, and present the received layers to a video display coupled to the viewing client 106. In some embodiments, the viewing client presentation player module 304 may present the video stream and/or data content presentation layers through a GUI provided by the viewing client GUI module 302.

The viewer presentation control module 306 may be configured to execute instructions from the viewer at the viewing client 106 (e.g., through the viewing client GUI module 302) in regard to controlling the video stream and/or data content presentation layers being presented by the viewing client presentation player module 304. When permitted by the parameters and/or limitations of the visual communication session, the viewer presentation control module 306 may enable the viewer to interact with data content being presented through a data content presentation layer received from the presentation server 102. Furthermore, a viewer may utilize the viewer presentation control module 306 to input data into a computer-fillable form presented through a data content presentation layer received from the presentation server 102. The viewer presentation control module 306 may permit the viewer at the viewing client 106 adjust data content presentation layers (e.g., size, move, and orientation) and may allow the viewer to control the overall visual communication session (e.g., stop, pause, or continue the session). As discussed herein, the viewer's control of aspects of the visual communication session may be limited ore restricted based on the parameters and/or limitation defined by the presentation operator for the visual communication session.

The viewing client video stream module 308 may be configured to present a video stream from the viewing client 106 to the presentation server 102. Though the video stream presented by the viewing client video stream module 308 may comprise a video stream of the viewer (e.g., as captured by a camera coupled to the viewing client 106), the video stream presented by the viewing client video stream module 308 may also comprise a video stream accessible by the viewing client 106 and selected by the viewer. For example, the viewer may select to stream to the presentation server 102 a video stored locally on the viewing client datastore 314. Depending on the embodiment, the viewing client video stream module 308 may comprise multimedia encoders adapted to generate a video stream decodable by the presentation server 102.

The download module 310 may be configured to facilitate download of a computer readable object, such as a file, based on a link received from the presentation server 102 and corresponding to the computer readable object. Upon receiving the download link from the presentation server 102, viewing client presentation player module 304 may present the link over the video stream layer being received from the presentation server 102, and may present the download link in a data content presentation layer disposed over the video stream layer. As discussed herein, when the download link is presented at the viewing client 106, it may be graphically represented as an icon or the like. Use (e.g., traversal) of the download link by a viewer at the viewing client 106 may initiate download of the computer readable object to the viewing client 106. The downloaded computer readable object may be stored in and subsequently accessible from the viewing client datastore 314. Depending on the embodiment, the download link received from the presentation server 102 may be configured to initiate a download of the corresponding computer readable object from the presentation server 102 or from a computer system separate from the presentation server 102 (e.g., 3^{rd} party server).

The viewing client communication module 312 may be configured to facilitate communication between the viewing client 106 and the presentation server 102 through the network 104. The various components of the viewing client 106 may utilize the viewing client communication module 312 when transmitting or receiving data to and from the presentation server 102.

FIG. 4 is a flowchart illustrating an example method 400 for visual communication in accordance with various embodiments. For some embodiments, method 400 may be implemented using various components of the presentation server 102 and the viewing client 106, as described above. Before method 400 begins, a presentation operator may instruct the visual communication session module 204, through the presentation operator graphical user interface (GUI) module 202, to provision a visual communication session. Based on the provision request, the visual communication session module 204 may assign an existing, but inactive, visual communication session to the presentation operator. If one does not already exist, the visual communication session module 204 may create (e.g., setup) a new visual communication session for the provision request. When visual communication session is created, preliminary information regarding the visual communication session, such as the presentation operator's information and/or the viewer's information, may be stored in a datastore, such the presentation server datastore 224. The preliminary information may subsequently utilized in reserving computing resources for the visual communication session, and may be utilized in the generation of a link that corresponds to the visual communication session.

Method 400 may begin at step 402, where the visual communication session link module 206 may generate a link corresponding to a visual communication session between the viewing client 106 and the presentation server 102. The link generated by the visual communication session link module 206 may be provided by the presentation operator to a viewer at the viewing client 106, possibly by way of text message or e-mail. Depending on the embodiment, generating the link may involve storing an association between the link and the corresponding visual communication session. This association may be stored at the presentation server 102, preferably in the presentation server datastore 224.

At step 404, the visual communication session module 204 may establish the visual communication session between the viewing client and the presentation server based on the link. In particular, the visual communication session may be established when the viewer at the viewing client 106 uses (e.g., traverses) the link to initiate establishment of the visual communication session corresponding the visual communication session. For some embodiments, use of the link by the viewer at the viewing client 106 may cause a web browser on the viewing client 106 to visit a specific website that provides and initiates software facilitating the visual communication session through the web browser for the viewer. Additionally, use of the link by the viewer at the viewing client 106 may cause a web browser on the presentation server 102 to visit a specific website that provides and initiates software facilitating the visual communication session through the web browser for the presentation operator. The viewer's software and the presentation operator's software may connect the visual communication session module 204 to establish the visual communication session.

At step 406, the presentation server video stream module 208 may present to the viewing client 106 a video stream layer of the visual communication session. In some embodiments, the video stream layer may be controlled by the presentation operator through the presentation operator presentation control module 214.

At step 408, the data content presentation module 210 may present to the viewing client the data content presentation layer over the video stream layer. In some embodiments, the data content presentation layer may be controlled by the presentation operator through the presentation operator presentation control module 214.

At step 410, the data presentation module 210 may further receive user input data from a viewer at the viewing client 106. The user input data may be received through the data content presentation layer being presented by the data presentation module 210 to the viewing client 106. The user input data once received may be stored in the presentation server datastore 224. In some instances, the presentation operator may be prevented from accessing the user input data received.

Those skilled in the art will appreciate that the order in which the steps of method 400 are illustrated and described in no way limits method 400 under various embodiments. For some embodiments, method 400 may performed such that less than all the steps of method 400 are performed and/or the steps of method 400 are performed in an alternative order than what is shown in FIG. 4.

FIG. 5 is a block diagram illustrating an example user interface 500 for visual communication in accordance with various embodiments. As show in FIG. 5, the user interface 500 may comprise: a viewer area 502, a document panel 504, a tools panel 506, a visual catalog panel 508, and a presentation control panel 510. For some embodiments, a presentation operator may utilize the user interface 500, provided by a presentation server, to control various aspects of the virtual communication session. Some aspects controllable through the user interface 500 may include, for example: adjusting the location, size, shape, number or specifying/changing of a data content being presented through a given data content presentation layer; start, pause, or end pause or end a visual communication session; invite one or more additional viewers to an active visual communication session; initiate and/or accept a chat session with a viewer through a visual communication session; configure the data content presentation layer to mask one or more specific portions of data content it presents; define parameters and/or limitations regarding what a viewer at a viewing client can and cannot do; control selection, sequencing, and/or playing of pre-recorded videos, which can facilitate vide-based puppetting; selecting a computer readable object and provide a viewing client with a download link to the selected computer readable object; preparing and generating a computer calendar reminder regarding a scheduled visual communication session.

In the context of FIG. 2, the user interface 500 may be provided to the presentation operator by the presentation operator GUI module 202. As noted herein, the user interface 500 may be implemented using HTML 5, Adobe® Flash®, or like technology.

The viewer area 502 may be configured to present a presentation operator with a video stream received by the presentation server 102 from viewing client 106 during a visual communication session. As noted herein, the video stream received from the viewing client 106 (e.g., the viewing client video stream module 308) may be one captured at the viewing client 106 (e.g., by a camera coupled to the viewing client) during the visual communication session. Alternatively, the video stream received and presented in the viewer area 502 may be from stored multimedia accessible by the viewing client 106 and selected by the viewer.

Some or all of the viewer area 502 may further be configured to function as a shared region (also referred to as, the “active region”), where the shared region shares visibility and/or control, of one or more data content presentation layers present in the region, with the viewer at the viewing client 106 and the presentation operator at the presentation server 102. The shared region of the viewer area 502 may be configured to share visibility and/control of only those portions of the data content presentation layers present in the shared region. Updates to the data content presentation layers presented through the shared regions may be shared between the viewing client 106 and the presentation server 102 at or near real-time. Accordingly, as the presentation operator adds data content presentation layers to the shared region or removes such layers from the shared region, the shared region will update to reflect the changes.

For some embodiments, the presentation operator may permit to adjust the shared region within the viewer area 502, with respect to its size, shape, or location for example. The presentation operator may further be allowed to define parameters and limitations regard the visibility and/or control by the viewing client 106 of the data content presentation layers present in the shared region.

The availability of the share region facilitates the presentation operator's control of one or more data content presentation layer (e.g., location, size, orientation) presented to the viewer at the viewing client 106. Effectively, the presentation operator can drag-and-drop data content presentation layers to and from the shared region of the viewer area 502 when adding or removing such layers, and drag-and-drop data content presentation layers in order to size, orient, or re-location such layers in the shared region of the viewer area 502. For some embodiments, the viewer area 502 may continue presenting video stream from the viewing client 106 while a data content presentation layer, disposed over the video stream from the viewing client 106, is presented in the viewer area 502.

Preferably, the shared region of the viewer area 502 covers the entirety of the viewer area 502. Additionally, in some embodiment, the viewer area 502 is sized according to the display coupled to the viewing client 106. For instance, where the viewing client 106 is a mobile phone, the viewer area 502 may be sized according to the small screen of the mobile phone.

The document panel 504 may be configured to provide a listing of computer readable objects that the presentation operator can present to the viewing client 106 through one or more data content presentation layer. To present an item from the document panel 504, the presentation operator may select an item in the document panel 504 and drag-and-drop the item from the document panel 504 to the shared area of the viewer area 502. The drag-and-drop action may cause the presentation server 102 (e.g., data content management module 212) to access the computer readable object (e.g., document, spreadsheet, image, or multimedia file) represented by the selected item and cause the presentation server 102 (e.g., the data content presentation module 210) to present to the viewing client 106 the data content from the accessed computer readable object in a data content presentation layer.

The tools panel 506 may provide functionality for managing data content presentation layers in the shared region of the viewer area 502. Management of the data content presentation layer may include adding, removing, sizing, moving, and orienting a data content presentation layer in the shared region. The tools panel 506 may further permit the presentation operator to select and access computer readable object not listed in the document panel 504, to adjust settings for the user interface 500, or present a computer-fillable form through a data content presentation layer.

The visual catalog panel 508 may be configured to present a list of multimedia computer readable objects that can be accessed and presented through one or more data content presentation layers in the shared region of the viewer area 502. At times, the multimedia computer readable objects are listed as graphical icons that correspond to the objects. The multimedia computer readable objects listed in the visual catalog panel 508 may include, without limitation, audio files, video files, presentation files (e.g., Microsoft® PowerPoint®), and animation files. The visual catalog panel 508 may list multimedia computer readable objects relating to one or more products or services (e.g., flowers, infomercial products, and travel arrangements), which the presentation operator may be attempting to sell to the viewer at the viewing client 106, or for which the presentation operator may be providing general customer service. Presentation of the multimedia computer readable objects to the viewing client 106 may comprise the presentation operator dragging-and-dropping multimedia computer readable objects from the visual catalog panel 508 to the shared region of the viewer area 502. The multimedia computer readable objects in the visual catalog panel 508 may be populated by an administrator of the presentation server 102 with computer readable objects relating to products, services, or sales material to be utilized by presentation operators during visual communication sessions.

In some embodiments, the visual catalog panel 508 may present a listing of pre-recorded videos that facilitate the presentation and control of a video-based puppet. As discussed herein, in various embodiments, video-based puppeteering can be achieved by way of using pre-recorded videos that correspond to different movements by a particular individual. Generally, the pre-recorded videos are presented through the video stream layer and, when presented, take the place of the video stream of the presentation operator. With a library of such pre-recorded videos for an individual (e.g., 500 different movements), the presentation operator can select a set of pre-recorded videos that will be presented to the viewing client 106. Effectively, the selection of the pre-recorded video gives the presentation operator the ability to control an individual for visual communication sessions.

The presentation control panel 510 may provide the presentation operator with overall control of the visual communication session, chat discussions during the visual communication session, and generating links/download links. For example, the presentation control panel 510 may be configured to allow the presentation operator to stop, pause, or continue the visual communication session. With respect to the chat discussion, the presentation operator could initiate and/or end a chat session during a visual communication session. Additionally, through the presentation control panel 510, the presentation operator can generate a link to a new or existing visual communication sessions (e.g., for inviting others to a current visual communication session) and can generate a download link to be used by the viewing client 106 to download a computer readable object.

FIG. 6 is a screenshot of an example mobile viewing client 600 participating in visual communication in accordance with various embodiments. As shown in FIG. 6, the mobile viewing client 600 may comprise a video display 602 configured to present a video stream layer 604 and a data content presentation layer 606, each of which may be provided by a presentation server (e.g., 102).

In the example of FIG. 6, the mobile viewing client 600 has established a visual communication session with a doctor at a presentation server (e.g., 102). Depending on the embodiment, the doctor may be controlling the visual communication session as the presentation operator. The video stream layer 604, as depicted in FIG. 6, presents a live or pre-recorded video stream of the doctor. Based on the doctor's arm position, the doctor appears to be presenting a patient x-ray. The data content presentation layer 606, as depicted in FIG. 6, presents the patient x-ray.

As noted herein, the viewer at the mobile viewing client 600 may instruct the viewing client 106 to adjust the presentation of the layers provided by the presentation server 102. The adjustment to the presentation of the layers may be restricted by parameters and/or limitations defined by the presentation operator (e.g., the doctor). FIG. 7 is a screenshot of the mobile viewing client 600 after the viewer at the mobile viewing client 600 adjusted the presentation of layers. As shown in FIG. 7, the video stream layer 604 has been hidden from view, and the presentation of the data content presentation layer 606 has been adjusted to be full screen on the video display 602.

FIG. 8 is a screenshot of the mobile viewing 600 client where patient x-ray presented through the data content presentation layer 606 in FIGS. 6 and 7 has been replaced by a computer-fillable form. The presentation of the computer-fillable form through the data content presentation layer 606 may be based on control inputs provided to the presentation server (e.g., 102) by the presentation operator.

FIG. 9 is a block diagram of an exemplary digital device 900. The digital device 900 comprises a processor 902, a memory system 904, a storage system 906, a communication network interface 908, an I/O interface 910, and a display interface 912 communicatively coupled to a bus 914. The processor 902 is configured to execute executable instructions (e.g., programs). In some embodiments, the processor 902 comprises circuitry or any processor capable of processing the executable instructions.

The memory system 904 is any memory configured to store data. Some examples of the memory system 904 are storage devices, such as RAM or ROM. The memory system 904 can comprise the ram cache. In various embodiments, data is stored within the memory system 904. The data within the memory system 904 may be cleared or ultimately transferred to the storage system 906.

The storage system 906 is any storage configured to retrieve and store data. Some examples of the storage system 906 are flash drives, hard drives, optical drives, and/or magnetic tape. In some embodiments, the digital device 900 includes a memory system 904 in the form of RAM and a storage system 906 in the form of flash data. Both the memory system 904 and the storage system 906 comprise computer readable media which may store instructions or programs that are executable by a computer processor including the processor 902.

The communication network interface (com. network interface) 908 can be coupled to a network (e.g., network 104) via the link 916. The communication network interface 908 may support communication over an Ethernet connection, a serial connection, a parallel connection, or an ATA connection, for example. The communication network interface 908 may also support wireless communication (e.g., 802.11 a/b/g/n, WiMax). It will be apparent to those skilled in the art that the communication network interface 908 can support many wired and wireless standards.

The optional input/output (I/O) interface 910 is any device that receives input from the user and output data. The optional display interface 912 is any device that is configured to output graphics and data to a display. In one example, the display interface 912 is a graphics adapter.

It will be appreciated by those skilled in the art that the hardware elements of the digital device 900 are not limited to those depicted in FIG. 9. A digital device 900 may comprise more or less hardware elements than those depicted. Further, hardware elements may share functionality and still be within various embodiments described herein. In one example, encoding and/or decoding may be performed by the processor 902 and/or a co-processor located on a GPU (i.e., Nvidia®).

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

As used herein, a “module” may comprise software, hardware, firmware, and/or circuitry. In one example one or more software programs comprising instructions capable of being executable by a processor may perform one or more of the functions of the modules described herein. In another example, circuitry may perform the same or similar functions. Alternative embodiments may comprise more, less, or functionally equivalent modules and still be within the scope of present embodiments. For example, the functions of the various modules may be combined or divided differently.

As used herein, the term “set” may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

Various embodiments are described herein as examples. It will be apparent to those skilled in the art that various modifications may be made and other embodiments can be used without departing from the broader scope of the invention(s) presented herein. These and other variations upon the exemplary embodiments are intended to be covered by the present invention(s).

What is claimed is:

1. A method comprising:
generating a link corresponding to a visual communication session between a viewing client and a presentation server;
establishing the visual communication session between the viewing client and the presentation server based on the link, the visual communication session comprising a video stream layer and a data content presentation layer;
presenting to the viewing client the video stream layer; and
presenting to the viewing client the data content presentation layer over the video stream layer, the presentation of the data content presentation layer being controlled by the presentation operator through the presentation server.

2. The method of claim 1, further comprising receiving user input data received, through the data content presentation layer, from a viewer at the viewing client.

3. The method of claim 1, wherein the data content presentation layer presents content from a computer readable object.

4. The method of claim 3, wherein the computer readable object is accessible by the viewing client but not otherwise accessible by the presentation server.

5. The method of claim 3, wherein the computer readable object is accessible by the presentation server but not otherwise accessible by the viewing client.

6. The method of claim 1, wherein the data content presentation layer presents a computer-fillable form configured to receive user input data from a viewer at the viewing client.

7. The method of claim 1, wherein the data content presentation layer presents a download link corresponding to a computer readable object downloadable by the viewing client.

8. The method of claim 1, wherein the video stream layer presents a set of pre-recorded videos selected by the presentation operator, and in an order selected by the presentation operator.

9. The method of claim 8, wherein the set of pre-recorded videos are presented such that video stream layer appears to presenting live video.

10. The method of claim 1, wherein the link uniquely corresponds to the visual communication session.

11. The method of claim 1, wherein the link is disabled while the visual communication session is active.

12. The method of claim 11, wherein the link is enabled when the visual communication session is inactive.

13. The method of claim 1, further comprising collecting analytical information regarding the visual communication session.

14. A system comprising:
means for generating a link corresponding to a visual communication session between a viewing client and a presentation server, the visual communication session comprising a video stream layer and a data content presentation layer;
means for establishing the visual communication session between the viewing client and the presentation server based on the link;
means for presenting to the viewing client the video stream layer; and
means for presenting to the viewing client the data content presentation layer over the video stream layer, the presentation of the data content presentation layer being controlled by the presentation operator through the presentation server.

15. A system comprising:
a link module configured to generate a link corresponding to a visual communication session between a viewing client and a presentation server;
a visual communication session module configured to establish the visual communication session between the viewing client and the presentation server based on the link, the visual communication session comprising a video stream layer and a data content presentation layer;
a video stream module configured to present to the viewing client the video stream layer;
a data content presentation module configured to present to the viewing client the data content presentation layer over the video stream layer; and
a presentation operator control module configured to allow a presentation operator to the presentation of the data content presentation layer by the data content presentation module.

16. The system of claim 15, wherein the data content presentation layer is configured to receive user input data from a viewer at the viewing client.

17. The system of claim 15, wherein the data content presentation layer presents content from a computer readable object.

18. The system of claim 17, wherein the computer readable object is accessible by the viewing client but not otherwise accessible by the presentation server.

19. The system of claim 17, wherein the computer readable object is accessible by the presentation server but not otherwise accessible by the viewing client.

20. The system of claim 15, wherein the data content presentation layer presents a computer-finable form configured to receive user input data from a viewer at the viewing client.

21. The system of claim 15, wherein the data content presentation layer presents a download link corresponding to a computer readable object downloadable by the viewing client.

22. The system of claim 15, wherein the video stream layer presents a set of pre-recorded videos selected by the presentation operator and in an order selected by the presentation operator.

23. The system of claim 22, wherein the set of pre-recorded videos are presented such that video stream layer appears to presenting live video.

24. The system of claim 15, wherein the link uniquely corresponds to the visual communication session.

25. The system of claim 15, wherein the link is disabled while the visual communication session is active.

26. The system of claim 25, wherein the link is enabled when the visual communication session is inactive.

27. The system of claim 15, further comprising an analytics module configured to collect analytical information regarding the visual communication session.
